(19) United States
(12) Patent Application Publication
(10) Pub. No.: US 2009/0094212 A1
(43) Pub. Date: Apr. 9, 2009

(54) NATURAL LOCAL SEARCH ENGINE

(76) Inventor: Jon Scott Zaccagnino, Flemington, NJ (US)

Correspondence Address: JOHN F. LETCHFORD, ARCHER & GREINER, P.C., ONE CENENNIAL SQUARE, HADDONFIELD, NJ, 08033, US

(21) Appl. No.: 12/246,593

(22) Filed: Oct. 7, 2008

Related U.S. Application Data
(60) Provisional application No. 60/978,630, filed on Oct. 9, 2007.

(51) Int. Cl. G06F 7/06; G06F 17/30

(52) U.S. Cl. 707/3; 707/E17.018; 707/E17.108

(57) ABSTRACT

A method and system for searching for local information on a self-contained network of computers using natural words (keywords) that are native or familiar to a geographic location or searcher. The method and system do not employ prior or predetermined personal information about a searcher to perform the search. Rather, they utilize only the location, which is entered with the search. Accordingly, more relevant search results are returned based upon the predefined categorization of the local information and its relationship with a searcher's natural words and the natural words' relationship to the geographic location, all of which are predefined by authors of the local information who are uniquely familiar with such things as local slang, trade, profession and industry terms, local terms, acronyms, colloquialisms, and the like.

### CROSS REFERENCE TO RELATED APPLICATION

This application claims the benefit of U.S. Patent Application No. 60/978,630, filed Oct. 9, 2007, which is incorporated herein by reference in its entirety.

### FIELD OF THE INVENTION

The present invention relates in general to Web-based search engine and in particular to a search engine for providing optimal search results based on the locality of the searcher.

### BACKGROUND OF THE INVENTION

Searching for local information such as news, events, businesses, products, services, notices, etc., on the Web is best performed when one knows, precisely, the name and location of the information's author. For example, “Bert's sandwich shop, in Flemington N.J.” or “Bert's Sandwiches, 08822”. Search engine algorithms generally do a good job of indexing and sorting through the various names or other terms and their locations in respect to corresponding information provided on Web pages. Local information may include Web pages, Adobe® PDFs, images, etc., that are contained on a network of computers.

However, the difficulty comes into play when looking for “what” one wants in a specific geographic area because describing the “what” is subjective and, further, subject to local slang, trade, profession & industry terms, local terms, acronyms, colloquialisms, and the like. In many instances, if the author of the local information does not use the exact words that potential searchers might use, the chances of connecting may be remote, if not impossible. For example, consider a Web search constructed as “Sandwich shop 08822”. If an author posting a Web page employs the phrase “sub restaurant” in the descriptive information of its business, then that information most likely will not appear in the search results.

Other inventions have used “translation processes” to transform search word(s) into another term that is based upon predefined user demographics and location data which is then used to modify the search query before the search term is sent to a search tool. The first challenge here is that the user must enter their demographic information prior to searching and select which way they want to modify their query accordingly. This is arduous and does not provide easy or fast search results for the typical search, considering that their information needs to be updated frequently, and tastes change. The real benefit that is missing in this process, and is valuable to searchers, is for a process that takes advantage of the cumulative searches, their locality and the results that are used by various and several other searchers over time. There is no learning either, it is more about data filtering of one's own attributes than anything. The second challenge this invention does not address is that the search tool's algorithms rely again on keywords which can come in many variations that the system and the searcher may not have considered in predetermining the personal demographics and their relationship to the search words in order to make modifications.

Another challenge is that the location can be too specific such as when a town or zip code is used. For instance, two locations can be literally 10 feet away from each other yet physically reside in two separate towns or zip codes, thereby resulting in Web pages having only the exact zip code or town information being produced in the search results.

Published U.S. Patent Application No. 2007/0233649 (“'649 application”) addresses the use of keywords and location in search queries by creating a hybrid index. This patent uses the content of an object, (i.e., a Web page) to determine the keywords and location. This invention does not take into account tracking the object's relevancy to its true location. Relevancy is assumed because of the words used within the object. For example, if a Web site for a restaurant located in San Diego, Calif. mentioned that it carried “Brooklyn beer” then the invention disclosed in the '649 application would assume that this page must be about Brooklyn, N.Y., unless the Web page clearly state that it is located in San Diego. However, even if the restaurant's physical address was somewhere provided on the same Web page the invention disclosed in the '649 application would index this object as both San Diego and Brooklyn in any state. In addition, this system does not take into account user selections which would make the system “smart”. Using the same example, if San Diego, Calif. and Brooklyn, N.Y. were stored as part of the location in the hybrid index, and users consistently chose San Diego as the obvious choice this invention does not learn from its experience and will continue to show the same results. The '649 application also requires that location be entered as part of the query. It cannot glean the location from the search terms. This invention is typical of keyword searching algorithms and indexing in that it assumes relevancy based upon exact keyword matches rather than interpreting what the searcher means based upon the location in which they are searching.

U.S. Pat. No. 6,850,934 (“'934 patent”) takes the search query and translates it based upon predefined demographic and location information about the searcher. This invention requires prior knowledge of the searcher's demographics and location in order for it to translate the search into words that are more “normalized”. This invention described in the '934 patent does not provide any process or method for the search process. Instead, it simply modifies the search words before sending the query to a search tool based upon predefined translations terms. It is basically a process to take what is familiar to a searcher and make it more standardized for searching. For example, the '934 patent system perceives the searcher to be a 15 year old girl from San Francisco, Calif., and if the searcher searches for the word “pop” (intending to find information on “pop culture”), then based upon a predefined translation for the word “pop” for 15 year old girls in San Francisco the system will provide an automatic translation of the query for “pop” to the word “soda pop”. The '934 patent also does not take into account historical user data to produce more relevant translations. For example, even if the 15 year girl in the example above was provided with both “soda” and “pop culture” in the search results, she could then choose to select “pop culture” as she desired. Significantly, however, the '934 patent system would not intelligently learn change its translation terms to accommodate the translation “pop culture” as the preferred or primary translation for the term “pop” over time.

Most prior systems for local geographic area Web searching that use location as a way to refine the search for information use keywords, location and other information that is contained within the object or Web page. The problem with this approach is that humans, the authors of such data, are not always uniformly logical and consistent and do not write information in exactly the same way to describe the information or its location. Information is often written to convey something which is usually not exactly how many persons may search for it. This is why most prior systems produce results for local searching that are not very relevant.

Currently there are two methods or systems that are the de facto ways to find local information on the Web. Even though each system has unique characteristics they typically fall into one of the following two categories.

### Search Engines

Search engines use spiders or automated robots to index each Web page on the Web and then rank the pages based upon words contained within the page. This indexing process is generally how all major search engines work. As between them it is usually the page ranking algorithm that varies. Each engine normally uses a proprietary process to rank the pages to make them more relevant to the searcher. Searchers are presented the most relevant Web pages based upon their search words. If there is no mention of geographic location in a Web page then most search engines have no method to make the Web page locally relevant. If there is location information within a Web page then the search engines can provide a more relevant result when the searcher uses the same location information in their search as that provided by the author of the Web page. For example, if a searcher uses the words “Flemington” and “pizza” in his or her search and a New Jersey pizzeria uses “Hunterdon County” but not “Flemington” on its website then there will be no match. In addition, as noted above, presently existing search engines rely on keywords that can be subjective to both the author of the Web page and the searcher. Examples of such search engines include Google®, Yahoo® and MSN®.

### Online Directories

Directories are primarily databases of information that are categorized with Internet Yellow Page (IYP) categories (these categories typically are the same as those found in printed yellow pages) along with their location and/or key words. The information tends to be mostly business information, not news, events, or the like. Examples of local directories include Superpages.com, Local.com and MerchantCircle.com. Typically, a searcher must enter a location and search term(s), otherwise the system cannot filter what data to return for the category or keyword selected. Perhaps the most significant difference between search engines and online directories is that search engines search the entire Web, whereas online directories only search their own data. Directories, however, are not “smart” systems capable of understanding local slang, trade, profession & industry terms, local terms, acronyms, colloquialisms, and the like. Further, presently known directories are incapable of “learning” and adapting to such idiosyncrasies or variables over time.

### SUMMARY OF THE INVENTION

The present invention provides a method and system for searching for local information on a network of computers using natural words (keywords) that are native or familiar to geographic locations. Such keywords may or not be familiar to a searcher. The method and system do not employ prior or predetermined personal information about a searcher to perform the search. Rather, they utilize only the geographic location where information is sought, which location is preferably, but not necessarily, entered with the search. Accordingly, more relevant search results are returned based upon the predefined categorization of the local information and its relationship with the searcher's natural words and the natural words' relationship to the location, all of which are predefined by authors of the local information who are uniquely familiar with such things as local slang, trade, profession and industry terms, local terms, acronyms, colloquialisms, and the like. Locations may be determined by zip code, county, state, region or other similar natural or man-made geographic based parameters.

The present invention uses a system of predefined keywords that are associated with sets of specific category strings that categorize the local information data. Category strings desirably include a category, sub-category and specialty category. Keywords are further refined by their association with a physical geographic location which is defined by the system in various ways such as zip code, county, self created region, trade type, etc. The system then learns which category string is most relevant to a searcher's natural word and location query by employing a weighting system which takes into account the searcher's category string selection. The weighting system becomes “smarter” as more and more searches are executed. Indeed, if some natural words and locations become commonly related to one another, then those relationships may automatically have a category string permanently associated with them thereby eliminating the need for a searcher to select the appropriate category string in the future.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 shows how local information is entered, tagged and stored on the Natural Local Search Engine system according to the invention;

FIG. 2 shows the overview of the Natural Local Search Engine system; and

FIG. 3 shows how natural search words are matched with category strings.

### DETAILED DESCRIPTION OF THE INVENTION

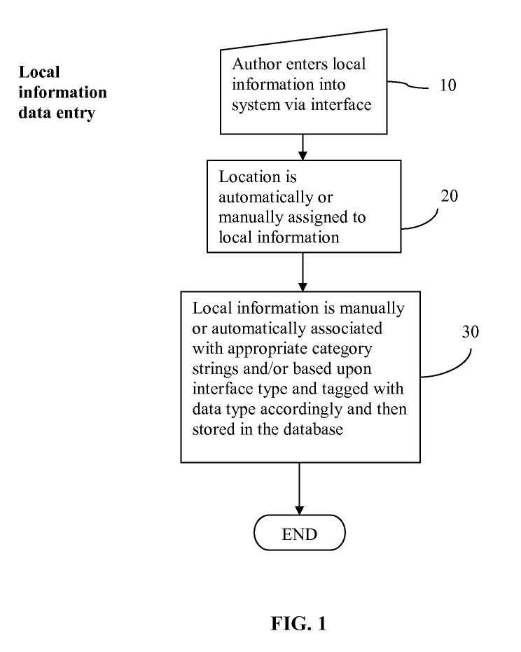

Referring to the drawings wherein like or similar references indicate like or similar elements throughout the several views, there is shown in FIG. 1 a schematic representation of how an Web page author posts information to the natural local search engine system according to the present invention.

As represented by reference numeral 10, local information is entered into the system by an author via a graphical user interface that preferably varies depending upon the type of information being entered into the system. For example, a news entry would have different data than an event entry. At step 20 the local information is automatically assigned a location based upon the author's predetermined location or via a manual entry by the author. At step 30 local information is then associated with appropriate category strings and/or information type prior to being stored in the system. The type of local information is based upon which user interface the information is entered. Alternatively, it can be assigned manually by the author during the information entry phase. A category string preferably includes a Main Category, a Sub-category and a Specialty Category. A category string does not necessarily require a specialty category and may consist only of a main and Sub-category. Examples of category strings may include “Restaurant—Italian” or “Legal—Lawyer—Divorce”. Along with a geographic location, natural words that may be associated with the latter category string may be “divorce attorney”, “marriage lawyer”, “breakup counselor”, or the like, which are stored in the natural word database.

Information types associated with an entry, may include, for example, news, sports, events, etc. Following input of the information type, assignment of the information type (automatic or manual), assignment of Sub-category and, possibly, a Specialty Category the process of data entry, categorization and storage is completed.

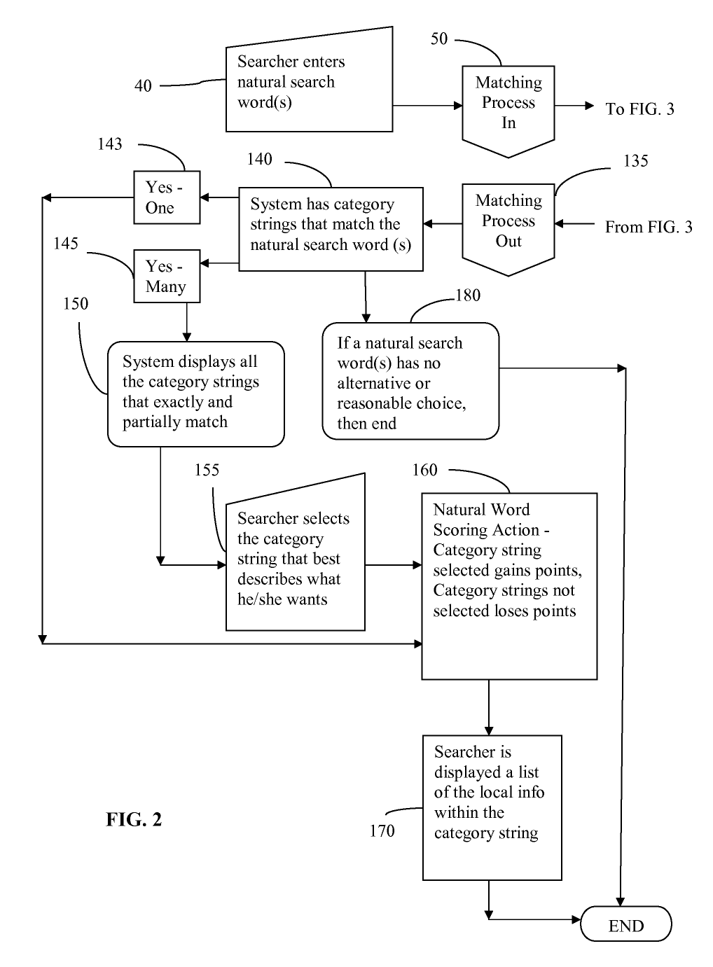

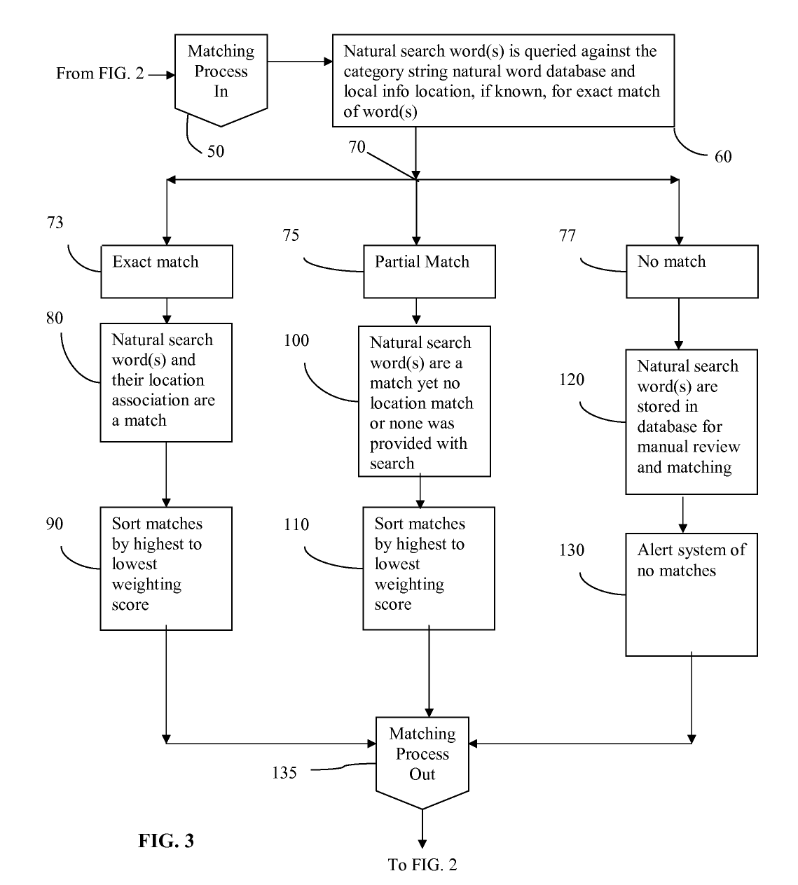

Referring to FIG. 2, at step 40 a Web searcher enters natural words that are familiar either to himself/herself or associated with the location pertaining to the local information he/she desires to acquire. At step 50, the system then matches the natural search words entered by the searcher with appropriate category strings in the manner represented in FIG. 3.

Referring to FIG. 3, at step 60 the system searches a natural word database for a match for any category strings that contain the natural search words entered by the searcher. At step 70, the system generates three options for matching, discussed below: “Exact” 73, “Partial” 75 or “No match” 77 which pertain to category and location association.

As reflected at step 80, an exact match occurs when the natural search word(s) and the location association are identical or considered identical with a scrubbing process—such as plural versus singular words. In development of the database, a particular geographic location may not exist or be available at the time of search. Hence, the first search for a location is for any matches regardless of location association. If at least one exact match has been made, at step 90 the system generates category string(s) that are sorted by the highest weighted category string to the lowest and outputs the results of the matching process at “Matching Process Out” step 135.

As reflected at step 100, partial matches are produced which are defined as having natural search word(s) being matched that do not yet have a geographic location association. The absence of a location association may be because the location has not been provided by the searcher or the category strings are weighted lower than exact matches. At step 110 the system presents a list of partial matches which are sorted by the highest weighted category string to the lowest (i.e., the frequency of which category strings are selected by users) and outputs the results of the matching process at “Matching Process Out” step 135.

At step 120, if there are no matches then the searcher is presented with a note stating this. And, at step 130, when there are no matches, the system stores the natural search words and the location searched, if available, for review and category string assignment and outputs the results of the matching process at “Matching Process Out” step 135.

Returning to FIG. 2, the results of the “Matching Process Out” step 135 of FIG. 3 are parsed at step 140. More specifically, at step 140 the system may determine that the natural search words match up with only one category or the other choices are mathematically not a reasonable choice (option 143). In that event, the system will proceed to step 160, discussed below. According to the invention, a choice may be determined to be not “mathematically reasonable” based upon its relevance in scoring to the highest weighted category string. The calculation that makes category strings not “mathematically reasonable” or not a mathematical choice arises when the weighting score is negative or the higher weighted category string is more than “X” times the value of a lower weighted category string, where “X” may be, for example, a factor of from greater 1 and up to about 35.

At option 145, the system may determine that the natural search words entered by the searcher match up with more than one category. In that case, at step 150 the searcher is then presented with the list of all exact and partially matched category strings. At step 155 the searcher then selects the category string that is most relevant to himself/herself and/or his/her location (or a remote location in which the searcher is interested). At step 160 the system then automatically assigns “points” or value to the category string that was selected for future weighting or scoring purposes. The assigned points are higher for an exact match with location and lower for partial matches or when no location is provided as part of the search. At step 170 the searcher is then presented with a list of the local information that is within the selected category string.

As shown at step 180, the system may determine that no matches, i.e., no alternatives or reasonable choices, exist for a particular search query. In that event, the searcher is presented with this info and the search process is completed.

All searchable data associated with the present invention is self-contained on the system's database and defined by the authors who are content providers of the database. That is, the present system is not a generalized search engine which performs relatively unfocused searches of the Web in the manner of Google® or other “non-local” search engine search. In contrast, the database of the instant invention is populated with data provided by authors, which persons are especially familiar with local slang, trade, profession and industry terms, local terms, acronyms, colloquialisms, and the like. In this way, the data is highly geo/demographic-specific thereby resulting in search results that are uniquely tailored to the search input provided by a Web searcher interested in information i.e., goods, services, news, events, or other information associated with a particular geographic location. Thus, a person searching the Web for particular geographically localized information is more likely to quickly find precisely what he or she is looking for without having to perform multiple, iterative or “guesswork” searches as may be required when using a generalized Web search engine.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A method for searching local geographic information on a Web-based search engine comprising the steps of:
(a) providing a computer accessible database consisting of local geographic information populated by at least one author familiar with words that are native or familiar to at least one geographic location;
(b) querying only said database with at least one word that is native or familiar to at least one geographic location; and
(c) providing search results in response to step (b).

2. The method of claim 1 wherein step (b) further comprises querying said database with a geographic location in addition to said at least one word that is native or familiar to the at least one geographic location.

3. The method of claim 1 wherein said local geographic information is stored on said database and is tagged with information type data upon its entry into said database.

4. The method of claim 1 wherein said local geographic information may be further categorized using category strings.

5. The method of claim 4 wherein said category strings are defined by at least one of manual and automatic input associated with said at least one word.

6. The method of claim 5 wherein said category strings are prioritized by category strings containing said at least one word associated with a geographic location followed by category strings containing said at least one word not associated with a geographic location.

7. A system for searching local geographic information on a Web-based search engine comprising:
(a) a computer accessible database consisting of local geographic information populated by at least one author familiar with at least one word that is native or familiar to at least one geographic location; and
(b) means for accessing said database.

8. The system of claim 7 wherein said local geographic information is stored on said database and is tagged with information type data upon its entry into said database.

9. The system of claim 7 wherein said local geographic information may be further categorized using category strings.

10. The system of claim 9 wherein said category strings are defined by at least one of manual and automatic input associated with at least one word used to query said database.

11. The system of claim 10 wherein said category strings are prioritized by category strings containing said at least one word associated with a geographic location followed by category strings containing said at least one word not associated with a geographic location.

12. The system of claim 10 wherein said category strings are prioritized by weighting relative to the frequency of which category strings are selected by users when searching said database.

13. The system of claim 12 wherein said weighting comprises scoring selected category strings positively and unselected category strings negatively relevant to a geographic location.

14. The system of claim 7 wherein the system does not employ information regarding a searcher prior to conducting a search of said database.

15. The system of claim 9 wherein the category strings are comprised of a main category and a sub-category.

16. The system of claim 15 wherein the category strings further comprise a specialty category.

17. The system of claim 7 wherein locations may be determined by zip code, county, state, region or other similar natural or man-made geographic based parameters.
